(19) United States
(12) Patent Application Publication
(10) Pub. No.: US 2012/0177755 A1
(43) Pub. Date: Jul. 12, 2012

(54) REPELLANT FORMULATION

(76) Inventor: Michael King, Broadbeach (AU)

(21) Appl. No.: 13/497,023

(22) PCT Filed: Dec. 18, 2009
(86) PCT No.: PCT/AU09/01639

§ 371 Date: Mar. 19, 2012

(30) Foreign Application Priority Data
Sep. 18, 2009 (AU) 2009904534

(51) Int. Cl. A01N 65/26; A01P 17/00; A01N 65/08

(52) U.S. Cl. 424/734; 424/761

(57) ABSTRACT

A repellent formulation comprising an amount of Neem Oil. The present invention provides, for the first time, a repellent formulation that, rather than chemically affecting the food supply of birds, acts by imparting a bitter and unpleasant taste when the repellent is transferred from the birds feet and feathers to its mouth when preening.

### FIELD OF THE INVENTION

The present invention relates to a repellent formulation. In particular, this invention relates to a repellent formulation which is used to deter bird species from treated areas, and therefore will be described in this context. However, it will be appreciated that the repellent formulation may be used to deter other animals from treated areas.

### BACKGROUND OF THE INVENTION

A large number of modern residential and commercial properties include outdoor entertainment areas with swimming pools, water features and grassed areas. In these areas, substantial bird visits have resulted in unsightly, unhealthy bird droppings which can damage grass and other vegetation, promote growth of weed, pollute pools and other water bodies which, as a consequence, detract from a positive outdoor experience. As visiting birds leave behind their excrement in the water and surrounds, increased cleaning requirements resultant from staining and excrement build up are required. The excrement further serves to feed visiting and breeding insects, further encouraging repeat bird and new bird visits.

A number of methods to deter birds from outdoor areas such as entertainment areas, water bodies and large vegetative areas currently exist. These include the use of ribbons or string placed across the desired area, however this approach may be considered unsightly. One method has been the use dedicated dogs that will actively pursue birds which visit these outdoor areas. As this method requires a confined or trained dog in residency, this also can be an undesirable solution. Numerous inflatable and mechanical devices mimicking birds of prey and snakes have been placed in a water body or nearby, however this has been met with only limited success.

To address this limited success, chemical methods have been developed to deter aquatic birds such as ducks and other waterfowl from visiting water bodies per se. One known formulation is based on the irritant algaecide benzalkonium chloride in products such as “No More Ducks” (Lo-Chlor, Australia). While adding chemicals to water bodies, for example water features and fountains to deter bird visits; it is less desirable to add unwanted chemicals to swimming pools and spas. Further, these in situ pool chemicals do not deter bird visits to nearby surrounds.

Another approach used to deter birds in unwanted outdoor areas include a goose and duck repellent based on methyl anthranilate, the active constituent found in grape skins, see for example, the Liquid Fence Company (USA). The formulation is unpalatable to geese, turkeys and ducks and is applied to grassed areas and other natural bird food supplies as well as to fences and foot paths etc.

### OBJECT OF THE INVENTION

Accordingly, it is an object of the invention to provide a formulation for repelling bird species from treated outdoor areas which overcomes or alleviates one or more of the problems of the prior art or provide a useful commercial alternative.

### SUMMARY OF THE INVENTION

According to a first aspect of the present invention there is provided a repellent formulation comprising an amount of Neem Oil.

Preferably, the repellent formulation further comprises an amount of pepper.

Also preferably, the repellent formulation further comprises an amount of garlic.

Still preferably, the repellent formulation further comprises an amount of water.

More preferably, the repellent formulation further comprises an amount of emulsifier.

Suitably, the repellent formulation comprises an amount of Neem oil between 10-90%.

More suitably, the repellent formulation comprises an amount of pepper between 10-100 g/L.

Still more suitably, the repellent formulation comprises an amount of garlic up to 100 g/L.

Even more suitably, the repellent formulation comprises an amount of water between 0-90%.

Optionally, the repellent formulation comprises 0-3% by volume of an emulsifier.

Preferably, the ratio of Neem oil; pepper is between 30-90% w/w:10-30 g/L.

More preferably, the ratio of Neem oil; garlic is between 30-90% w/w:10-50 g/L.

More preferably, the ratio of Neem oil; pepper; garlic; water; emulsifier is between 10-90%:10-30 g/L; 10-30 g/L:10-90%; 0.05-3% w/w.

According to a second aspect of the invention, there is provided a method of repelling birds from treated outdoor areas including the step of forming a repellent formulation of the first aspect and the step of applying an effective amount of said formulation to a surface.

So that the invention can be understood in more detail, the skilled person is referred to the following non-limiting preferred embodiments.

### DETAILED DESCRIPTION OF THE PREFERRED EMBODIMENTS

The present invention provides, for the first time, a repellent formulation that, rather than chemically affecting the food supply of birds, acts by imparting a bitter and unpleasant taste when the repellent is transferred from the birds feet and feathers to its mouth when preening.

It will be appreciated that this repellent formulation advantageously comprises natural substances of plant origin that are suitable for repelling bird species from treated surfaces.

The following constituents are selected for their specific properties and their interaction, such that when combined, provide a repellent formulation suitable for surface coating applications.

Neem seed oil, or margosa oil has numerous applications including that of pesticides for tomatoes, leaf lettuces, strawberries and broccoli crops, natural contraceptives, oral and hair care, skin care, cosmetics, topical antibacterial treatments, anti-mosquitoes control and protection as well as flee, tick and mange pet treatments. Neem oil may be extracted from the seed kernel and/or by the Neem tree leaves. While Neem oil provides an initial repellent odour to birds, Neem oil has a strong and elevated bitter taste. When birds land on a treated surface, traces of the repellent formulation are transferred to the mouth via the preening process.

Pepper is a natural animal repellent, such that when brought into contact by birds, brings about a strong hot burning sensation. Cayenne pepper is added to increase the repellent activity of the formulation. Cayenne pepper also acts as an emulsifier in the formulation, having both hydrophilic and lipophilic properties. While cayenne pepper is used in this example, other forms of pepper of the genus capsicum may be used, for example Habanero, Paprika, Red, Hot, Chilli, Spanish and Jalepeno Peppers. Preferably, peppers with high concentrations of amount of capsaicin as measured by the Scoville scale are used.

Garlic is natural, non-toxic insect repellent containing significant sulphur content. Garlic is optionally added to impart an unpleasant odour to visiting birds and add to the already nutty and garlic odour of Neem oil. Garlic acts as an emulsifier in the formulation, having both hydrophilic and lipophilic properties. While powdered garlic is preferred for ease of dissolution, other forms of extracted garlic may also be used.

The repellent formulation may further optionally comprise emulsifiers. Any emulsifier that is compatible with an aqueous environment may be used.

Water is optionally used as a vehicle and provides ease of application for the repellent formulation. A non-aqueous repellent formulation may alternatively be applied at temperatures from 30 to 35° C.

A typical formulation ‘batch’ of 1 L is prepared using the following method. The formation of a repellent formulation of the present invention includes the initial step of dissolving 15 g cayenne pepper and 15 g garlic powder in 100 mL of warmed water. To this solution, 200 mL Neem Oil is added and the mixture is shaken. While pure Neem oil is preferred, various Neem oil preparations with high Azadirachtin content may also be used and include Neem oil extracted from Neem tree seeds or leaves, crude Neem oil and raw Neem oil.

To this mixture, the remaining 700 mL of water is added and the mixture shaken. Optionally, 2 mL of an odourless emulsifier is added to assist in maintaining a homogenous mixture. The formulation is bottled and stored out of direct sunlight at room temperature. The formulation is shaken before use. If the container is stored below 25 C.°, the Neem oil will solidify. To assist in applying the formulation more evenly, the formulation may be warmed by placing the closed container in a bucket of warm water for several minutes before shaking. The repellent formulation is applied to the desired surface by roller, brush, mop or similar device. A typical formulation provides surface coverage of 5 m² per 1 L.

As used herein, “covering” means “apply”, “applying”, “coat” or “coating” using the repellent formulation to form a thin dry film when applied to a surface.

Commonly effective areas to apply the repellent formulation include the edging or ‘coping’ swimming pools and other like contained water bodies such as water features.

It will be appreciated that use of the repellent formulation in other areas which attract birds such as ducks are also contemplated. The repellent formulation has strong commercial advantages in areas of golf courses and in particular, the putting green areas which require higher maintenance due to bird excrement and damage. Other commercial uses may be found in bird concentrated areas such as jetty and pontoon areas as well as hotel and commercial swimming pool areas. Surrounding areas such as roofing, tiles and decking are other areas that may find advantageous commercial and residential applications.

The repellent formulation further finds application when applied to surfaces that give birds, and particularly ducks and geese, their best vantage point. For example, the repellent formulation may be applied to popular sites of bird visits such as street light posts, at end of boat piers, pier pole supports, on boat surfaces, for example, on top of boat masts, swim platforms and sculptures.

The time period of formulation effectiveness averages from 7 to 10 days per application and is influenced by environmental factors, whereby both rain and high temperatures reduce the effectiveness of the formulation.

In order that the invention may be readily understood and put into practical effect, particular embodiments will now be described by way of the following non-limiting example.

### Example

Table 1 below shows concentration ranges of each constituent which may be used to formulate the Repellent Formulation of the present invention.

TABLE 1
Repellent Formulation

| | Preferred | | |
|---|---|---|---|
| Component | amount | | Range of effectiveness |
| Neem Oil | 20% | w/w | 10-100% w/w using pure Neem |
| | | | oil having a concentration of 3741 |
| | | | ppm. Higher volumes are required |
| | | | if the concentration of Neem oil |
| | | | in the Neem oil preparation is |
| | | | lower than 3741 ppm. |
| Pepper | 15 | g/L | 10-100 g/L, depending on heat |
| | | | unit rating |
| Garlic | 15 | g/L | 0-100 g/L; If no garlic is used, an |
| | | | amount from 300 mL of Neem oil |
| | | | is preferably used |
| Water | 80% | w/w | 0-90% w/w |
| emulsifier | 2% | w/w | 0-3% w/w; optional |

It will be appreciated that until now, there has been no successful repellent formulation for birds, and in particular, a repellent for birds visiting outdoor areas, and in particular, wet areas such as pools, grasses, jetties and other like areas.

Conveniently, the repellent formulation of the present invention comprises a safe, natural method of repelling birds such as ducks, geese, ibises and galahs from visiting outdoor areas, and in particular, wet areas such as pools, grasses, jetties and other like areas.

It will also be appreciated by the skilled person that the present invention is not limited to the embodiments described in detail herein, and that a variety of other embodiments may be contemplated which are nevertheless consistent with the broad spirit and scope of the invention.

1. A repellent formulation comprising an amount of neem oil.

2. The repellent formula according to claim 1, wherein the repellent formulation further comprises an amount of a constituent selected from the group consisting of pepper, garlic, water, emulsifier, and combinations thereof.

3. (canceled)

4. (canceled)

5. (canceled)

6. The repellent formulation according to claim 1,
wherein the repellent formulation comprises an amount of neem oil between 10-90% by volume.

7. The repellent formulation according to claim 2,
wherein the repellent formulation comprises an amount of pepper between 10-100 g/L.

8. The repellent formulation according to claim 2,
wherein the repellent formulation comprises an amount of garlic up to 100 g/L.

9. The repellent formulation according to claim 2,
wherein the repellent formulation comprises an amount of water between 0-90% by volume.

10. The repellent formulation according to claim 2,
wherein the repellent formulation comprises 0-3% by volume of an emulsifier.

11. The repellent formulation according to claim 2,
wherein the ratio of neem oil:pepper is between 30-90% w/w:10-30 g/L.

12. The repellent formulation according to claim 2,
wherein the ratio of neem oil:garlic is between 30-90% w/w:10-50 g/L.

13. The repellent formulation according to claim 2,
wherein the ratio of neem oil:pepper:garlic:water:emulsifier is between 10-90% w/w:10-30 g/L:10-30 g/L:10-90% w/w:0.05-3% w/w.

14. A method of repelling birds from treated outdoor areas including the step of forming a repellent formulation comprising an amount of neem oil and the step of applying an effective amount of said formulation to a surface.

15. The repellent formula according to claim 2,
wherein the pepper comprises or is derived from a constituent selected from the group consisting of a cayenne pepper, a habanero pepper, a paprika pepper, a red pepper, a hot pepper, a chilli pepper, a Spanish pepper, a jalapeno pepper, and combinations thereof.

16. The repellent formulation according to claim 13,
wherein the ratio of neem oil:pepper:garlic:water:emulsifier is 20% w/w:15 g/L:15 g/L:80% w/w:2% w/w.

17. The method according to claim 14,
wherein the repellent formulation further comprises an amount of a constituent selected from the group consisting of pepper, garlic, water, emulsifier, and combinations thereof.

18. The method according to claim 17,
wherein the pepper comprises or is derived from a constituent selected from the group consisting of a cayenne pepper, a habanero pepper, a paprika pepper, a red pepper, a hot pepper, a chilli pepper, a Spanish pepper, a jalapeno pepper, and combinations thereof.
